(19) United States
(12) Patent Application Publication
(10) Pub. No.: US 2011/0052376 A1
(43) Pub. Date: Mar. 3, 2011

(54) INTER-STAGE SEAL RING

(75) Inventor: Kiran Sreeram, Greenville, SC (US)

(73) Assignee: GENERAL ELECTRIC COMPANY, Schnectady, NY (US)

(21) Appl. No.: 12/549,420

(22) Filed: Aug. 28, 2009

(51) Int. Cl. F02C 7/28

(52) U.S. Cl. 415/174.5

(57) ABSTRACT

The present application describes a turbine section. The turbine section may include a pair of rotors, a seal ring positioned between the pair of rotors, and a first weld at a first end of the seal ring and a second weld at a second end of the seal ring.

### TECHNICAL FIELD

The present application relates generally to gas turbine engines and aircraft and more particularly relates to a welded inter-stage seal and torque transmission ring.

### BACKGROUND OF THE INVENTION

Multistage turbines generally include a spacing device and an inter-stage seal positioned between the stages. The spacing device maintains a predetermined spacing between each turbine stage. The inter-stage seal prevents leakage of the gas compressed by the preceding stage. Specifically, an inter-stage seal may be located between two rotating disks and may cooperate with a turbine nozzle for providing a fluid seal therebetween to prevent or limit leakages therethrough. Aircraft engines may use similar designs.

Such inter-stage seals, however, may have issues with maintainability and reliability. For example, uneven temperature distributions during operation may result in relatively large tensile forces therein. Such forces may impact life cycle fatigue and even may propagate cracks therein. Moreover, known inter-stage seals generally may be attached to the rotors or elsewhere via bolts or other types of mechanical connection

There is thus a desire for an improved inter-stage seal. Such a seal preferably can provide adequate gas flow sealing and torque transmission while being easy to install and relatively light weight.

### SUMMARY OF THE INVENTION

The present application thus describes a turbine section. The turbine section may include a pair of rotors, a seal ring positioned between the pair of rotors, and a first weld at a first end of the seal ring and a second weld at a second end of the seal ring.

The present application further provides for a turbine section of a gas turbine engine. The turbine section may include a pair of rotors spaced apart from each other, a seal ring positioned between the pair of rotors, a first weld at a first end of the seal ring and a second weld at a second end of the seal ring, and a number of teeth positioned on the seal ring.

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a gas turbine engine.

FIG. 2 is a side plan view of a portion of a turbine section with the inter-stage seal ring as is described herein.

### DETAILED DESCRIPTION

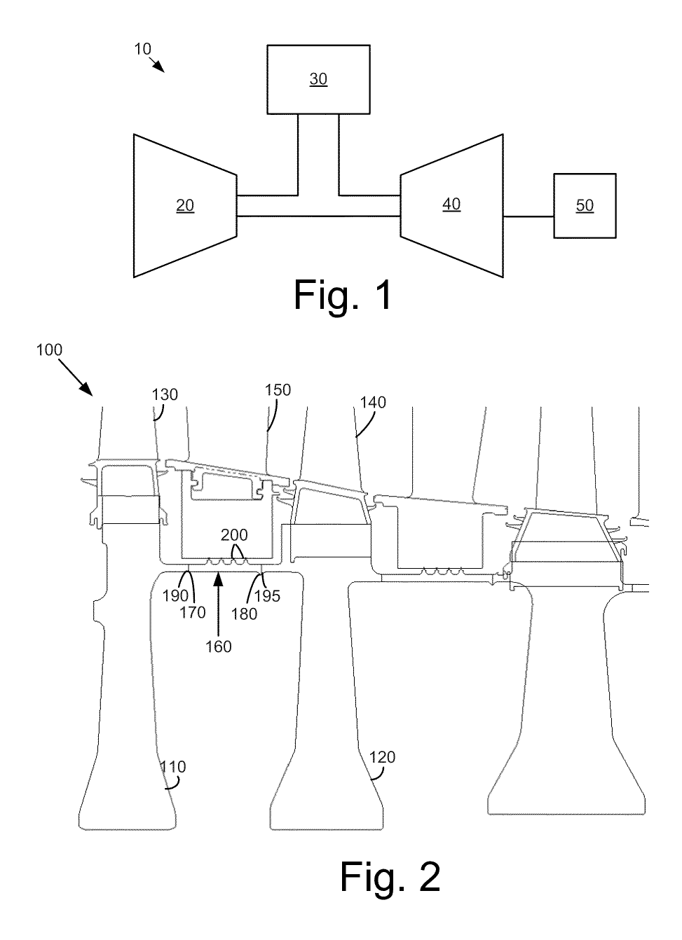

Referring now to the drawings, in which like numbers refer to like elements throughout the several views, FIG. 1 shows a schematic view of a gas turbine engine 10. As is known, the gas turbine engine 10 may include a compressor 20 to compress an incoming flow of air. The compressor 20 delivers the compressed flow of air to a combustor 30. The combustor 30 mixes the compressed flow of air with a compressed flow of fuel and ignites the mixture. (Although only a single combustor 30 is shown, the gas turbine engine may include any number of combustors 30.) The hot combustion gases are in turn delivered to a turbine 40. The hot combustion gases drive the turbine 40 so as to produce mechanical work. The mechanical work produced by the turbine 40 drives the compressor 20 and an external load 50 such as an electrical generator and the like. The gas turbine engine 10 may use natural gas, various types of syngas, and other types of fuels. The gas turbine engine 10 may have other configurations and may use other types of components herein.

FIG. 2 shows a turbine section 100 that may be part of the turbine 40 described above, an aircraft, or other types of devices with rotating disks. The turbine section 100 may include any number of rotor disks with a first rotor disk 110 and a second rotor disk 120 shown. The rotor disks 110, 120 are spaced from one another at a predetermined distance. Each of the rotor disks 110, 120 supports a turbine blade with a first turbine blade 130 and a second turbine blade 140 shown. A stator 150 or a similar fixed structure may project between the turbine blades 130, 140 and portions of the disks 110, 120. Similar designs may be used herein.

The turbine section 100 further may include a seal ring 160 as is described herein. The seal ring 160 may be attached to the first rotor disk 110 at a first end 170 thereof and to the second rotor disk 120 at a second end 180 thereof. The seal ring 160 may be attached at the first end 170 via a first weld 190 and at the second end 180 via a second weld 195. Other types of connection means maybe used herein. The welds 190, 195 may be continuous or intermittent. The seal ring 160 may include any number of labyrinth teeth 200 or similar types of seals. The labyrinth teeth 200 may be positioned so as to face the stator 150. Any number of labyrinth teeth 200 may be used. The labyrinth teeth 200 may have any desire size or shape.

In use, the seal ring 160 adequately prevents leakage via the use of the labyrinth teeth 200. The seal ring 160 itself also transmits torque therethrough. The use of the welds 190, 195 eliminates the nuts and bolts as used in known designs so as to provide a light weight design. The seal ring 160 further eliminates the use of the spacer so as to further reduce the costs and weight of the overall turbine 40. Further, seal displacements thus can be minimized so as to provide better clearance. Overall costs likewise may be reduced given the use of fewer parts. The seal ring 160 may be used between any type of rotating parts.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

I claim:

1. A turbine section, comprising:
a pair of rotors;
a seal ring positioned between the pair of rotors; and
a first weld at a first end of the seal ring and a second weld at a second end of the seal ring.

2. The turbine section of claim 1, further comprising a pair of turbine blades attached to the pair of rotors.

3. The turbine section of claim 1, further comprising a stator positioned between the pair of rotors.

4. The turbine section of claim 1, wherein the first and the second welds comprise a continuous weld.

5. The turbine section of claim 1, wherein the first and the second welds comprise an intermittent weld.

6. The turbine section of claim 1, wherein the seal ring comprises a plurality of teeth.

7. The turbine section of claim 6, wherein the plurality of teeth comprise a plurality of labyrinth teeth.

8. The turbine section of claim 1, wherein the seal ring transmits torque between the pair of rotors.

9. A turbine section of a gas turbine engine, comprising:
a pair of rotors spaced apart from each other;
a seal ring positioned between the pair of rotors;
a first weld at a first end of the seal ring and a second weld at a second end of the seal ring; and
a plurality of teeth positioned on the seal ring.

10. The turbine section of claim 9, further comprising a pair of turbine blades attached to the pair of rotors.

11. The turbine section of claim 9, further comprising a stator positioned between the pair of rotors.

12. The turbine section of claim 9, wherein the first and the second welds comprise a continuous weld.

13. The turbine section of claim 9, wherein the first and the second welds comprise an intermittent weld.

14. The turbine section of claim 9, wherein the plurality of teeth comprise a plurality of labyrinth teeth.

15. The turbine section of claim 9, wherein the seal ring transmits torque between the pair of rotors.
